(19) United States
(12) Patent Application Publication
(10) Pub. No.: US 2021/0371156 A1
(43) Pub. Date: Dec. 2, 2021

(54) POPCORN BOX WITH FLOSS STICKS

(71) Applicant: Devin Smith, Shreveport, LA (US)

(72) Inventor: Devin Smith, Shreveport, LA (US)

(21) Appl. No.: 17/068,567

(22) Filed: Oct. 12, 2020

Related U.S. Application Data
(60) Provisional application No. 63/033,642, filed on Jun. 2, 2020.

(51) Int. Cl. B65D 5/44; A61C 15/04

(52) U.S. Cl. CPC B65D 5/44; A61C 15/046

(57) ABSTRACT

The popcorn box with floss sticks provides a popcorn container with sanitary removable floss sticks as used to improve the user's ability to remove popcorn bits and kernels from his or her teeth quickly and discretely without having to leave the movie theater. These floss sticks can be used at the user's discretion to eliminate tooth and gum discomfort while watching a movie in a theater, thereby easily dislodging food particles. The floss sticks are covered in a protective covering, such as a film or a plastic film bag, so that the floss sticks remain sanitary before use, and can be disposed of in a sanitary fashion by being put back in their protective covering.

### CROSS-REFERENCE TO RELATED APPLICATION

The present application is related to and claims priority from prior provisional application Ser. No. 63/033,642, filed Jun. 2, 2020, the entire application of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of snack boxes and containers for comestibles. More specifically, the invention is a popcorn box that includes floss sticks so user's can remove popcorn kernels from between their teeth after eating.

### 2. DESCRIPTION OF THE RELATED ART

Flossing is extremely important for long-term care of teeth. Tooth decay, plaque, bad breath, and other conditions can occur without proper flossing. Moviegoers enjoy eating popcorn while watching their favorite movies on the big screen. However, this often results in popcorn particles and kernels becoming stuck in the teeth or gum area, causing discomfort. The discomfort may be so great that the moviegoer needs to leave the theater, missing part of the movie, or find other means, such as a finger nail or the edge of the popcorn box, to dislodge the irritant from the tooth or gum area, which may cause further harm to the movie-goer's mouth.

Ideally, a popcorn box with floss sticks should provide the user a quick and discrete way to remove popcorn bits and kernels from his or her teeth without having to leave the movie theater and, yet would operate reliably and be manufactured at a modest expense. Thus, a need exists for a reliable popcorn box with floss sticks to avoid the above-mentioned problems.

### BRIEF SUMMARY OF THE INVENTION

In view of the foregoing disadvantages inherent in the known snack box art, the present invention provides a novel popcorn box with floss sticks. The general purpose of the present invention, which will be described subsequently in greater detail is to provide a popcorn container with floss sticks as used to improve the user's ability to remove popcorn bits and kernels from his or her teeth quickly and discretely without having to leave the movie theater.

The presently claimed invention relates to a popcorn box with floss sticks attached to the outside of the box. These floss sticks can be used at the user's discretion to eliminate tooth and gum discomfort while watching a movie in a theater, thereby easily dislodging food particles. The floss sticks are covered in a protective covering so that the floss sticks remain sanitary before use, and can be disposed of in a sanitary fashion by being put back in their protective covering.

The present invention holds significant improvements and serves as a popcorn box with floss sticks. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, a popcorn box with floss sticks, constructed and operative according to the teachings of the present invention.

FIG. 1 shows a perspective view illustrating a popcorn box with floss sticks according to an embodiment of the present invention.

FIG. 2 is a perspective view illustrating a popcorn box with floss sticks according to another embodiment of the present invention.

The various embodiments of the present invention will hereinafter be described in conjunction with the appended drawings, wherein like designations denote like elements.

### DETAILED DESCRIPTION

As discussed above, embodiments of the present invention relate to a snack box and more particularly to a popcorn container with floss sticks as used to improve the user's ability to remove popcorn bits and kernels from his or her teeth quickly and discretely without having to leave the movie theater.

Generally speaking, the presently claimed invention is a popcorn box similar in size and shape to standard movie popcorn boxes and including one or more floss sticks on the outside of the box. Preferably, the popcorn box includes four floss sticks. The floss sticks have a film-type cover that keeps them sanitary by preventing any outside objects or substances from coming into contact with the floss sticks until they are used.

A floss stick is a popular device used for flossing teeth. A floss stick includes a generally Y-shaped portion formed from a rigid material such as plastic or wood, with a piece of floss tensioned between the short tips of the Y. A user can hold the long end of the Y-shaped portion and push the tensioned piece of floss in between two teeth without having to touch his or her mouth or the piece of floss.

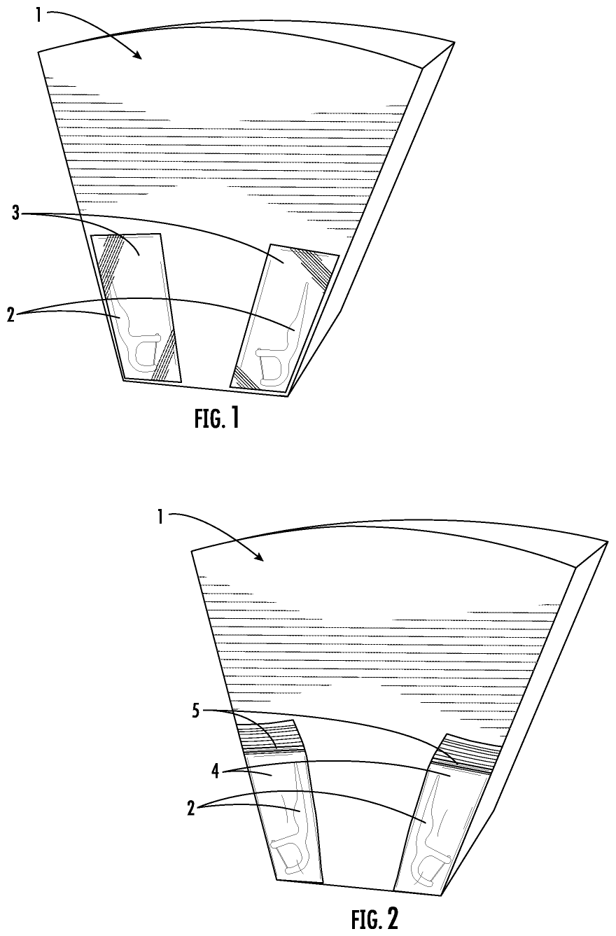

Referring to the drawings by numerals of reference there is shown in FIGS. 1-2, a popcorn box 1 has one or more floss sticks 2 attached thereon. The popcorn box 1 has may come in a variety of standard sizes for popcorn, and is preferably made of a thin cardboard or cardboard-like material. The popcorn box 1 may have a pattern printed on the outside, and may have a plastic coating on the outside to prevent grease from soaking through the popcorn box 1 to a user's hands. Preferably, the popcorn box 1 has two floss sticks 2 on one side and two floss sticks 2 on an opposing side or an adjacent side, for a total of four floss sticks 2. However, the popcorn box 1 could have one floss stick 2 per side, or four floss sticks 2 on one side.

As shown in FIG. 1, the floss stick 2 may be adhered to the popcorn box 1 by a cover 3 formed by a film or film-type material. This cover 3 encloses the floss stick 2, sealing the floss stick 2 to the outside of the popcorn box 1 and thereby providing a sanitary barrier between the floss stick 2 and possible contaminents. The floss stick cover 3 is adhered to the outside of the popcorn box 1 with a removable adhesive. The user may peel the cover 3 off the popcorn box 1, thereby exposing the floss stick 2 and allowing the floss stick 2 to be removed so the user can floss his or her teeth in a quick, convenient, and efficient manner Once flossing is complete, the user may simply discard the floss stick 2 into the popcorn box 1, if the popcorn box 1 is empty, or tuck the floss stick 2 back into the film-type cover 3 so the floss stick can be disposed of at the same time as the popcorn box 1 without a user or another person coming into contact with a used floss stick 2.

As shown in FIG. 2, the floss stick may alternately be enclosed in plastic film bag 4 with a zip-like re-sealable opening 5 at one end. The plastic film bag 4 is adhered to the outside of the popcorn box 1 with an adhesive. The adhesive is optionally a removable adhesive, to allow the user to remove the entire plastic film bag 4 from the popcorn box 1 if he or she wishes to do so. The floss stick 2 is completely contained within the plastic film bag 4, and does not come into contact with the popcorn box 1, in order to keep the floss stick 2 sanitary prior to use. The user may open the zip-like re-sealable opening 5 and remove the floss stick 2 so the user can floss his or her teeth in a quick, convenient, and efficient manner Once flossing is complete, the user may simply discard the floss stick 2 into the popcorn box 1, if the popcorn box 1 is empty, or tuck the floss stick 2 back into the plastic film bag 4 so the floss stick can be disposed of at the same time as the popcorn box 1 without a user or another person coming into contact with a used floss stick 2.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A popcorn box with floss sticks comprising:
a. a popcorn box;
b. at least one floss stick;
c. at least one floss stick cover, where there is one floss stick cover for each floss stick,
wherein the floss stick cover operably connects the floss stick to the popcorn box, and
wherein the floss stick cover maintains a sanitary barrier around the floss stick until the floss stick cover is removed.

2. The popcorn box with floss sticks according to claim 1, wherein there are four floss sticks and four floss stick covers.

3. The popcorn box with floss sticks according to claim 1, wherein the at least one floss stick cover is formed of a pealable film or film-like material, and
wherein the at least one floss stick cover is operably connected to an outside surface of the popcorn box by an adhesive material so that the at least one floss stick is sandwiched between the outside surface of the popcorn box and the at least one floss stick cover.

4. The popcorn box with floss sticks according to claim 1, wherein the at least one floss stick cover is formed of a plastic film bag with a zip-like re-sealable opening at a top end of the plastic film bag, and
wherein the at least one floss stick is enclosed within the at least one plastic film bag.

5. The popcorn box with floss sticks according to claim 3, wherein there are four floss sticks and four floss stick covers.

6. The popcorn box with floss sticks according to claim 4, wherein there are four floss sticks and four floss stick covers.
